(19) United States
(12) Patent Application Publication
(10) Pub. No.: US 2007/0043716 A1
(43) Pub. Date: Feb. 22, 2007

(54) Methods, systems and computer program products for changing objects in a directory system

(76) Inventors: Ronnie G. Blewer, Houston, TX (US); Lee McClendon, Sugar Land, TX (US); David Perdue, Bellaire, TX (US)

Correspondence Address: MYERS BIGEL SIBLEY & SAJOVEC, PO BOX 37428, RALEIGH, NC, 27627, US

(21) Appl. No.: 11/206,933

(22) Filed: Aug. 18, 2005

(51) Int. Cl. G06F 17/30

(52) U.S. Cl. 707/5

(57) ABSTRACT

Methods, systems and computer program products for changing an object associated with a directory system of a computer system and having a current classification are provided. A request to change the object is received. The request includes a specification of a new classification of the object different from the current classification of the object. A template is retrieved identifying attributes associated with the new classification and/or the current classification responsive to the received request. Attributes of the object to change are automatically identified based on a comparison of the template associated with the new classification and/or the current classification and on current attributes of the object responsive to the received request and the identified attributes are changed. The current classification and the new classification may be a position, a role and/or a location of the object and the object may be a user account and the attributes may include group memberships.

### BACKGROUND OF THE INVENTION

The present invention relates generally to administration of computer directory systems, and more particularly to administration of objects in such systems.

Various approaches have been taken to expand upon the earliest models for network administration, such as various Windows products from Microsoft Corporation which provided for specific users with extensive administrative powers designated on the system as administrators while other users are denied access to these administrative powers. Thus, security and administration of the network environment in such products is provided by bifurcating users into administrators who have administration authorities and users with no such authority.

Given the increased reliance on and complexity of the enterprise network environment, improvements to this basic administrator/user model have been provided in an attempt to allow controlled delegation of administrator authorities to designated users without requiring that such users be provided full administration powers and authorities over the network environment. Examples of such known approaches include the Windows 2000 Active Directory from Microsoft Corporation as well as other types of lightweight directory access protocol (LDAP) systems.

Active Directory is a feature supporting administration tasks. The Active Directory is a directory service that is integrated with Windows 2000 Server and Windows Server 2003 and offers hierarchical views, extensibility, scalability, and distributed security to business customers. The directory service is integrated with both Internet and intranet environments, provides intuitive naming for the objects it contains, scales from a small business to a large enterprise, works with familiar tools, such as Web browsers, and provides open application programming interfaces. In essence, Active Directory allows management of an enterprise environment.

Computer-based user account provisioning solutions, known as role-based access control (RBAC) systems, use the concept of an account template that is copied when creating a new user account. For example, a new employee named “Bob” joins the company MyCo, Inc. with the job title of “Marketing Director.” In a typical RBAC system, based on some data on Bob's position with the company, location, job title, etc., the RBAC system would create a new user account for Bob based on a role template, in this example for a Marketing Director. Cloning may also be supported, where a new user account is populated by copying the attributes from another user account.

Role Based Access Control systems may provide security benefits by standardizing access permissions based on a person's job and reduce or even eliminate errors associated with manual discovery and application of new user privileges, particularly errors which result in a user having more privileges than needed to do their job. They may also lower the cost of provisioning new user accounts as, once the account template roles have been defined within the RBAC system, customers can automate the process of creating user accounts, assigning group memberships, locating home shares, mailboxes, and the like associated with the new user. As a result, the savings from a well-implemented RBAC provisioning system can potentially run into the hundreds of dollars for each new employee.

A different process is generally used where an existing user account or the like needs to be changed. In one approach, each attribute of the user account is manually selected and changed. By way of example, this may involve manually removing each group membership to be lost and adding each one to be gained. As this job is often done by delegated help desk staffs, this typically is a haphazard, error-prone process. Often the end user does not know what they need to access in their new position and neither does the person making the manual change. The result may be that, when the end user discovers that they do not have the accesses they need for their new position, they call the help desk again, and additional manual action is taken. As a result, this may be a highly time-consuming process. In addition, there is a risk that the person's old, potentially sensitive access rights will be retained and the person will have more access than they need to get their job done.

Another approach is a “blind copy” update, where a person's entire access profile (role) is replaced by the new one. Any accesses that the person had that were neither part of the old or new role are lost, which may also result in help desk calls. For example, a user may desire to maintain existing permissions that are not directly related to their job title or role when their title/role changes. Similarly, a user may have several roles and a single change may occur that should not affect some of those roles.

### SUMMARY OF THE INVENTION

Embodiments of the present invention provide methods for changing an object associated with a directory system of a computer system and having a current classification. A request to change the object is received. The request includes a specification of a new classification of the object different from the current classification of the object. A template is retrieved identifying attributes associated with the new classification and/or the current classification responsive to the received request. Attributes of the object to change are automatically identified based on a comparison of the template associated with the new classification and/or the current classification and on current attributes of the object responsive to the received request and the identified attributes are changed. The current classification and the new classification may be a position, a role and/or a location of the object and the object may be a user account and the attributes may include group memberships.

In other embodiments of the present invention, automatically identifying attributes of the object to change includes comparing attributes identified in the template associated with the new classification with the current attributes of the object and identifying attributes to add to the object that are identified in the template and are not current attributes of the object. Automatically identifying attributes of the object to change may include comparing attributes identified in the template associated with the current classification with the current attributes of the object and identifying attributes to drop from the object that are identified in the template associated with the current classification and are current attributes of the object. Changing the identified attributes may include dropping the identified attributes that are identified in the template associated with the current classification and are current attributes of the object and adding the identified attributes that are identified in the template associated with the new classification and are not current attributes of the object without changing other attributes of the object.

In further embodiments of the present invention, changing the identified attributes includes changing a plurality of attributes of the object while retaining at least one attribute of the object without change. The object may be a user account and the attributes may include permissions and group memberships. The attributes may further include identification, address, computer resource allocation, telephone and/or organization properties.

In other embodiments of the present invention, changing the identified attributes is preceded by providing a summary of the identified attributes that will be changed and receiving a confirmation of the request to change the object responsive to providing the summary. In such embodiments, changing the identified attributes includes changing the identified attributes responsive to receipt of the confirmation. Receiving the confirmation may include receiving a designation of a change in a desired value of at least one of the identified attributes from the summary and changing the identified attributes may include changing the attributes based on the designation of a change in a desired value.

In yet further embodiments of the present invention, receiving a request to change the object includes receiving the request from a user account having associated powers over the object to be changed and changing the identified attributes includes determining if any identified attribute to add would escalate the associated powers over the object to be changed of the user account requesting the change and generating an error notification and denying addition of the identified attribute that would escalate the associated power if it is determined that the associated powers would be escalated. The directory may be an operating system directory of the computer system, a database directory and/or a secured computing application directory.

In other embodiments of the present invention, the methods further include receiving a designation of desired values for attributes of the object not included in a retrieved template and changing the identified attributes further includes changing attributes of the object to the received designated desired values. Receiving a request to change an object may include receiving a request to change a plurality of user account objects. In such embodiments, retrieving a template, automatically identifying attributes and changing the identified attributes may include generating a worklist defining a task for each of the plurality of user accounts and automatically retrieving a template, identifying attributes and changing attributes for each of the plurality of user accounts based on the worklist. A plurality of objects may be changed and the method may further include generating a log of changes to the plurality of objects.

In yet other embodiments of the present invention, the object is a user account and changing the identified attributes includes changing properties of an electronic mail (email) mailbox of the user account. The computer system may be a network and changing the identified attributes may include changing local attributes associated with the object on an individual computer on the network.

In further embodiments of the present invention, systems are provided for changing attributes of an object associated with a directory system of a computer system and having a current classification. The systems include a user interface configured to receive a request to change the object, the request including a specification of a new classification of the object different from the current classification of the object and a template database including a template identifying attributes associated with the new classification and/or a template identifying attributes associated with the current classification. An object transform module of the system identifies attributes of the object to change based on a comparison of the template associated with the new classification and/or the template associated with the current classification and on current attributes of the object and that changes the identified attributes.

In other embodiments, the request is received from a user account having associated powers over the object to be changed. The system may further include a security module that determines if any identified attribute to add would escalate the associated powers over the object to be changed of the user account requesting the change and generates an error notification and denies addition of the identified attribute that would escalate the associated power if it is determined that the associated powers would be escalated.

As will further be appreciated by those of skill in the art, while described above primarily with reference to method aspects, the present invention may be embodied as methods, apparatus/systems and/or computer program products.

### BRIEF DESCRIPTION OF THE FIGURES

FIG. 1 is a schematic diagram illustrating object transformation operations according to some embodiments of the present invention.

FIG. 2 is a block diagram illustrating object transformation operations according to some embodiments of the present invention.

FIG. 3 is a block diagram illustrating a data processing system that may be used for changing attributes of an object according to some embodiments of the present invention.

FIG. 4 is a flow chart illustrating operations for changing an object according to some embodiments of the present invention.

FIG. 5 is a flow chart illustrating operations for changing an object according to further embodiments of the present invention.

FIGS. 6-16 are screen shots of Graphic User Interface (GUI) screens for designating changes to an object according to some embodiments of the present invention.

### DETAILED DESCRIPTION OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention may be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

The present invention is described in part below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or lock diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks. Some embodiments of the present invention are described herein with reference to software/data objects. It will be understood that some embodiments of the present invention may be implemented using an object oriented design or procedural programming design.

Some embodiments of the present invention provide a role transformation mechanism that may allow a computer administrator to make the access changes to a user account (or other directory object) associated with a person's departmental job responsibility or location change as a single logical transaction, and in accordance with pre-defined access control templates. This may ensure that the user account loses access associated with the old location, job role or department, gains access to the access permissions associated with the new location, role or department, and/or leaves intact other accesses.

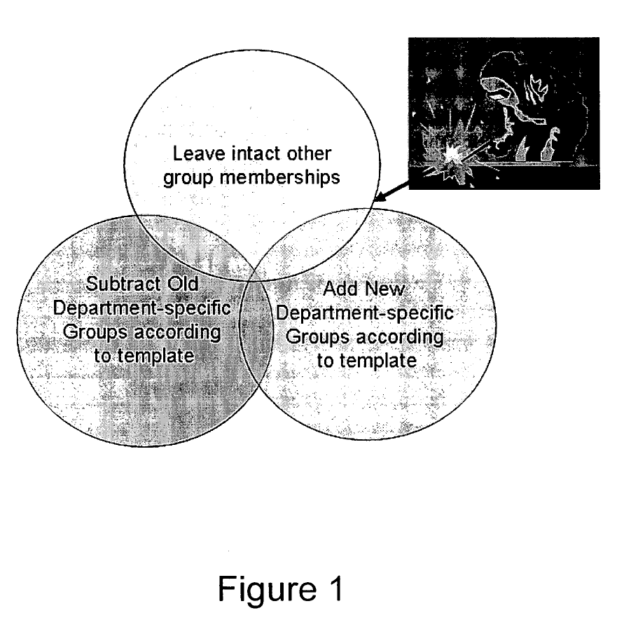

At the level of a help desk user or system administrator who must make these changes, such a role transformation mechanism may save significant labor time and cost (and potentially hours of corrective actions as discrepancies are uncovered), while reducing errors. The help desk may merely create a transaction that, in effect, says “Take away this user's permissions associated with this old job/role/location, give them permissions for the new one, and leave intact any associations that are not related to the old or new role.” Such a transaction is schematically illustrated in FIG. 1 in the context of group membership management responsive to a change in department for a user account.

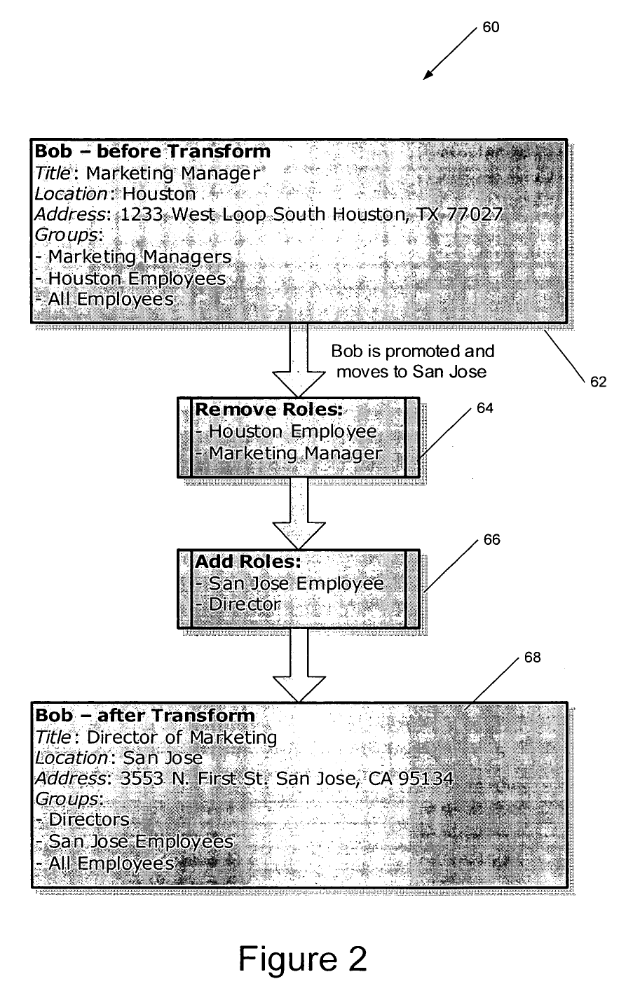

A role transformation is further illustrated for some embodiments of the present invention in the schematic diagram of FIG. 2. FIG. 2 illustrates an exemplary transformation 60 for a user “Bob,” who is being moved from a position as a Marketing Manager in Houston 62 to Director of Marketing in San Jose 68. During the transformation, the Houston Employees and Marketing Managers groups are removed 64 and the San Jose Employees and Directors groups are added 66. In addition, the Title, Location and Address attributes are changed as a result of the transformation. While not shown in FIG. 2, other attributes may remain unchanged after the transformation.

The role transformation mechanism illustrated in FIG. 2 may go beyond the conventional use of account role templates to provision (create) user accounts by supporting automated, granular re-provisioning. This re-provisioning may, nonetheless, benefit from the use of already available templates while providing additional capabilities for use by an administrator. When transforming a user, the user account can take on key attributes of another existing template account and/or lose key attributes of a previously applied template account. For example, with reference to the transformation of FIG. 2, when Bob moves from the Marketing Department to the Executive Department and/or from Houston to San Jose, as part of his new job duties, his user account(s) may need to be modified to reflect the access permissions and other job-related information so that he will: have access to the computing resources needed for his new position in the company; lose access to the computing resources associated with his old job; retain access to other computing resources that are not associated with either his new or old job role, but which he nevertheless still needs access to; have updated key attributes, such as address, office location, and the like.

In some embodiments of the present invention, role transformation may be implemented in a software product to provide methods of role transformation that would allow a user with account administration responsibilities (or an automated program taking advantage of this technology) to invoke a transaction in the user administration system to effect changes to allow access and remove access to respective computer resources and update key attributes while allowing a user to retain access to resources that are not associated with the new or old job role but are still needed by the user. In addition, the adding or deleting of access rights may be done independently of each other. For example, if Bob took on additional responsibility, the transform user method could be used to grant more access for this additional role without removing any access. Likewise, if Bob gave up some responsibility, the transform user could be used to remove access without granting any new access.

The administrative user (delegated help desk, system administrator or even automated program) in some embodiments simply selects the account that will be modified, optionally selects the account role template whose permissions will be removed from the user account access rights, and then selects the user account role template whose access permissions and attributes will be granted to the user. Any permissions or attributes not being added or removed may be left in place as part of the role transformation process. Such an approach may allow administrators to leverage existing RBAC role templates to serve as the basis for updating accounts in addition to the common implementations of RBAC, which typically only address the creation and deletion of user accounts.

Various embodiments of the present invention may address problems associated with the conventional approaches to changing user accounts. As contrasted with manual, one change at a time help-desk driven changes, the role transformation method may not require the help desk to know all the access rights that the person needs for their new job role, location, etc. The help desk can leverage the existing RBAC templates for user update operations in addition to user create operations. Thus, errors may be avoided even for complex changes. The actual transformation process may be much faster and more user friendly to the persons responsible for making the change, resulting in a faster turnaround. The user transformation may be less error-prone and, after the user transformation, the user may neither lose accesses that he/she still needs to do work in the computing system nor retain access that is no longer applicable to the job function being performed. As contrasted with the blind copy update approach, embodiments of the present invention may reduce the risk of or prevent the accidental elimination of job-specific accesses that are needed after the person changes job role, department or location, which may save man-hours in lost productivity.

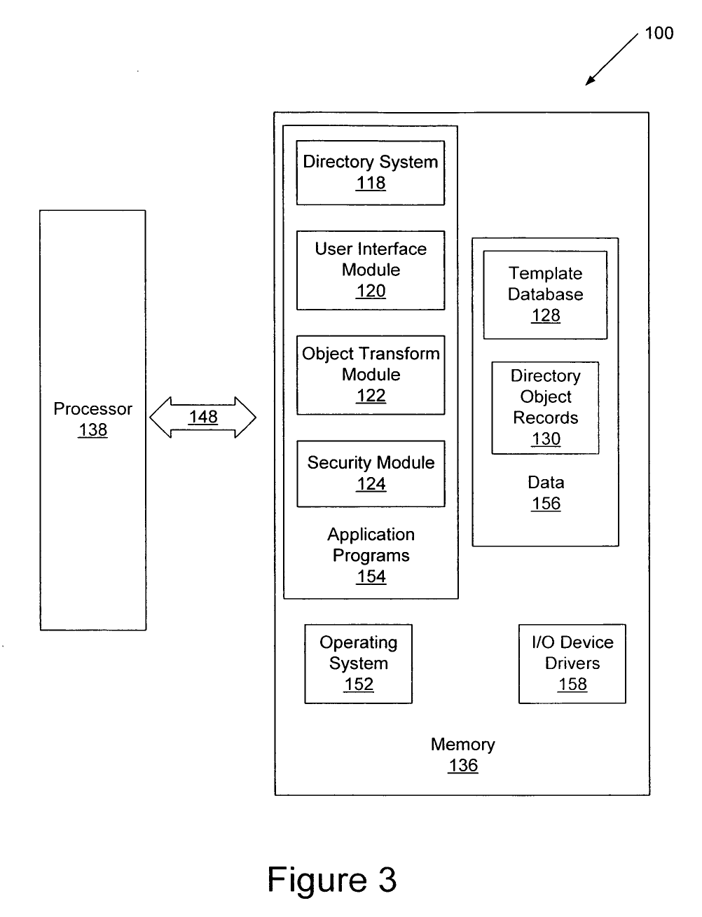

Embodiments of the present invention will now be further described with reference to FIG. 3. FIG. 3 is a block diagram illustrating a system for changing attributes of an object associated with a directory system of a computer system according to some embodiments of the present invention. FIG. 3 illustrates an exemplary data processing system 100 or database environment that may be included in devices operating in accordance with some embodiments of the present invention. As illustrated, the data processing system 100 includes a processor 138 and a memory 136. The data processing system 100 may be incorporated in, for example, a personal computer, server, router or the like. The processor 138 communicates with the memory 136 via an address/data bus 148. These components may be conventional components such as those used in many conventional data processing systems, which may be configured to operate as described herein.

In particular, the processor 138 can be any commercially available or custom microprocessor, microcontroller, digital signal processor or the like. The memory 136 may include any memory devices containing the software and data used to implement the circuits or modules used in accordance with embodiments of the present invention. The memory 136 can include, but is not limited to, the following types of devices: cache, ROM, PROM, EPROM, EEPROM, flash memory, SRAM, DRAM and magnetic disk. In some embodiments of the present invention, the memory 136 may be a content addressable memory (CAM).

As illustrated in FIG. 3, the memory 136 may include several categories of software and data used in the data processing system 100: an operating system 152; application programs 154; input/output device drivers 158; and data 156. As will be appreciated by those of skill in the art, the operating system 152 may be any operating system suitable for use with a data processing system, such as OS/2, AIX or zOS from International Business Machines Corporation, Armonk, N.Y., Windows95, Windows98, Windows2000, Windows2003 or WindowsXP from Microsoft Corporation, Redmond, Wash., Unix or Linux. The input/output device drivers 158 typically include software routines accessed through the operating system 152 by the application programs 154 to communicate with external devices and certain memory 136 components. The application programs 154 are illustrative of the programs that implement the various features of the circuits and modules according to some embodiments of the present invention. Finally, the data 156 represents the static and dynamic data used by the application programs 154, the operating system 152, the input/output device drivers 158, and other software programs that may reside in the memory 136.

As illustrated in FIG. 3, the data 156 may include a template database 128 and directory object records 130 according to some embodiments of the present invention. The template database includes a plurality of templates identifying attributes associated with object classifications. For example, templates may be associated with a job role, a job location or a job position for a user account object of a directory system 118. The templates in the template database 128 may be pre-existing organizational templates created under a RBAC system already in existence on a computer network of a corporation. The directory object records 130 are records reflecting the current attributes for the objects associated with the directory system 118. For example, a user account directory object record of the directory object records 130 may include group membership associated with the user account and/or other properties of the user account.

The application programs 154, in some embodiments of the present invention as illustrated in FIG. 3, include the directory system 118, a user interface module 120, an object transform module 122 and a security module 124. The directory system 118 may be an LDAP directory system, such as the Active Directory from Microsoft Corporation. It will also be understood that the directory system 118, while illustrated as part of the application programs 154, may be incorporated in the operating system 152 in some embodiments of the present invention.

The user interface module 120 is configured to receive the request to change an object. The request will include a specification of a new classification of the object, different from a current classification of the object. The object transform module 122 identifies attributes of the object to change based on a comparison of one or more templates associated with the new classification for an object and/or a template associated with a current classification and/or current attributes of the object. The object transform module 122 may also change the identified attributes.

As shown in the embodiments of FIG. 3, a security module 124 may also be provided. The security module 124 determines if any identified attributes to add to an object would escalate associated powers over the object to be changed of the user account requesting the change. In other words, if an administrator or help desk user attempts to change an attribute of a user account or other object over which they have limited powers and one of the attribute changes would increase those powers, an error notification may be generated by the security module 124. The security module 124 may also be configured to deny addition of an identified attribute that would escalate the associated power if it is determined that the associated powers of the requesting user would be so escalated.

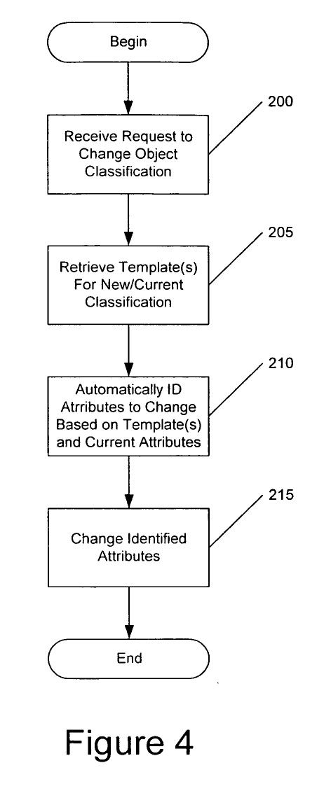

Embodiments of methods for changing an object associated with a directory system of a computer system will now be further described with reference to the flow chart illustration of FIG. 4. As shown in the embodiments of FIG. 4, a request is received to change the object (Block 200). The request includes a specification of a new classification of the object different from the current classification of the object. The classification associated with an object, either current or new, may be, for example, a position, a role and/or a location of the object. The object may be a user account and the attributes may include group memberships and/or other attributes of the object. A template is retrieved that identifies the attributes associated with the new classification and/or the current classification of the object to be changed responsive to the received request (Block 205). Attributes of the object to be changed are automatically identified based on a comparison of the template associated with the new classification and/or the current classification and on current attributes of the object responsive to the received request to change the object (Block 210). The identified attributes are then changed (Block 215).

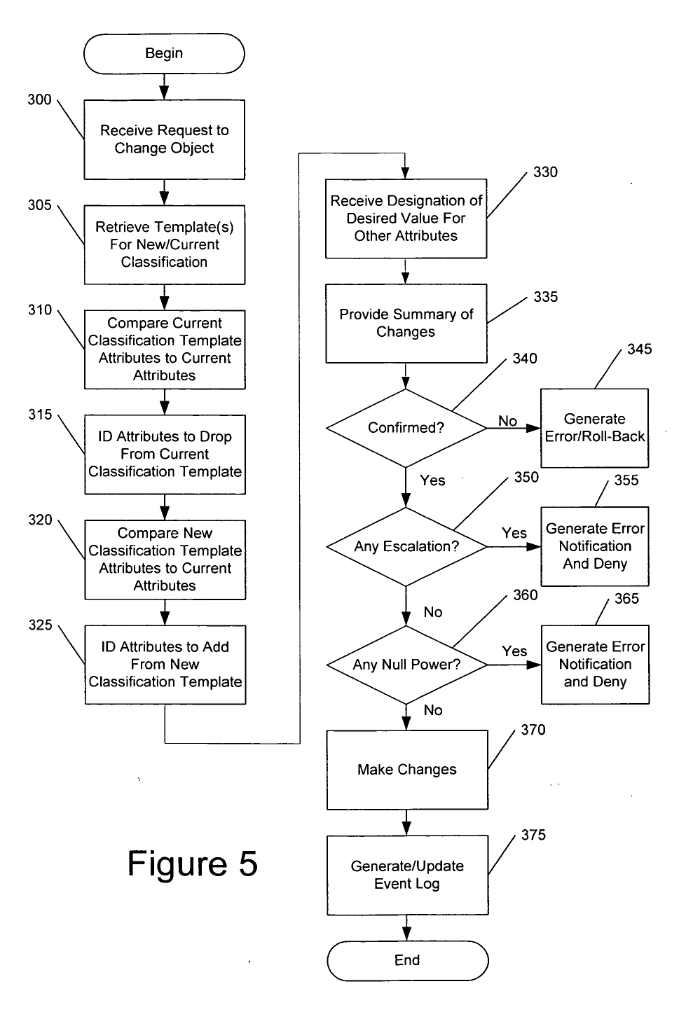

Further embodiments of the present invention will now be described with reference to the flow chart illustration of FIG. 5. As shown in the embodiments illustrated in FIG. 5, a request to change an object associated with the directory system of a computer system is received (Block 300). The request may be received, for example, from a help desk user or other administrator type user. Templates identifying attributes associated with a new classification and/or a current classification of the object are retrieved responsive to the request (Block 305).

As shown in FIG. 5 at Blocks 310 and 315, the change operation may include identification of attributes of an object that are to be removed. Attributes identified in the template associated with the current classification are compared with the current attributes of the object (Block 310). Attributes to drop from the object are identified as the attributes that are identified in the template associated with the current classification that are current attributes of the object (Block 315). As such, at Block 315 attributes currently held by the object that are also associated with the current classification that is being changed to a new classification will be identified to drop while attributes currently held by the object that are not associated with the classification that is being changed will not be identified.

As also shown in the embodiments of FIG. 5, the change operation may include identification of new attributes to add. Attributes identified in a template associated with the new classification are compared with current attributes of the object (Block 320). Attributes to add to the objects are identified as those that are identified in the template associated with the new classification that are not current attributes of the object (Block 325).

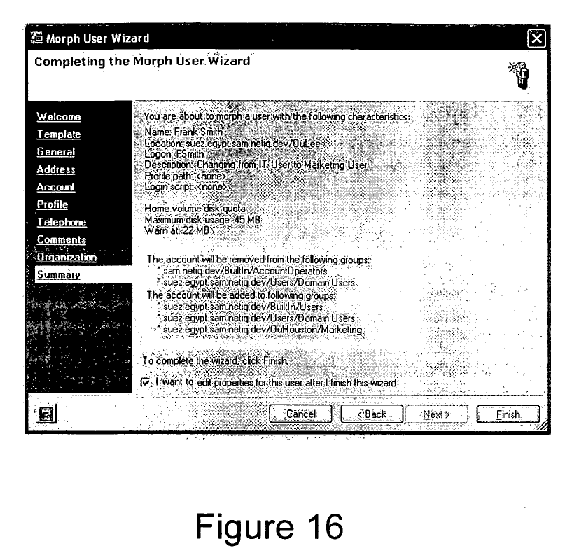

As further shown in the embodiments of FIG. 5, a designation of desired values for attributes of the object that are not included in a retrieved template may also be received (Block 330). As also shown in the embodiments of FIG. 5, a summary of the identified attributes that will be changed may be provided (Block 335). The summary may be provided as a GUI to display to a help desk or other user requesting the change, such as the summary screen shown in FIG. 16. A confirmation of the request to change the object is received from the requesting user responsive to providing of the summary (Block 340). If such a confirmation is not received (Block 340), a roll-back may be initiated to roll back any already implemented attribute changes and an error message may be generated (Block 345). In some embodiments of the present invention, the confirmation received at Block 340 may itself include a designation of a change from a desired value of one or more of the attributes identified as being changed in the summary and the implemented changes may be varied from the summary based on the designated change to the desired values for one or more of the attributes received with the confirmation at Block 340.

In some embodiments of the present invention, it may also be determined if any identified attribute to add would escalate the associated powers over the object to be changed of the user account requesting the change (Block 350). If it is determined that the associated powers would be escalated (Block 350), an error notification is generated and addition of the identified attributes that would escalated the associated power is denied (Block 355).

In some further embodiments of the present invention, it may also be determined if any identified attribute to drop would null the associated powers over the object to be changed of the user account requesting the change (Block 360). A null power check may ensure that the user account having associated powers over the object being changed does not lose[ ] If it is determined that the associated powers would be nulled (Block 360), an error notification is generated and droping of the identified attributes that would null the associated power is denied (Block 365).

The identified changes are made to the object responsive to the confirmation of the changes (Block 370). Changing the identified attributes may include dropping attributes that are identified in the template associated with the current classification that are current attributes of the object and adding identified attributes that are identified in a template associated with a new classification that are not current attributes of the object. The addition and deletion of the respective attributes may be done without changing other attributes of the object. Furthermore, in addition to the changes identified by reference to templates, additional changes designated either at Block 330 or Block 340 by a requesting user may be implemented at Block 370. The changed attribute may include identification, address, computer resource allocation, telephone and/or organization properties specified at Block 330 or Block 340. Attributes associated with permissions and/or group memberships may also be changed at Block 330 or Block 340.

A record for a log of changes to objects may be generated after the changes are made (Block 375). It will be understood that a plurality of changes may be made and the log may include entries corresponding to each of the respective change transactions that are provided by the transformation process of FIG. 5.

While described above with reference to a single transaction change request for an individual object from a help desk user or the like at Block 300, a plurality of changes may be automatically processed in some embodiments of the present invention. In such embodiments, for example, a requesting user may generate a work list defining a task for each of the plurality of user accounts. Operations at Blocks 305 through 375 may automatically repeat for each task in the work list associated with respective requested changes to objects. In such embodiments, each object may be provided a single task for the changes to the object or individual objects may have a plurality of work list tasks to implement the desired changes. For example, a user account may change position and location and each of position and location may have an associated template. The change to the user account may be treated as two tasks, one effecting the change in position and the other effect the change in location.

As described above, various embodiments of the present invention provide for implementing changes to an existing object under a directory system. The directory system 118 may be an operating system directory of the computer system, such as Active Directory, a database directory and/or a secured computing application directory. In addition, attributes changed may include attributes affecting properties of applications or the like outside the directory itself. For example, changing the identified attribute may include changing properties of an electronic mail (email) mailbox of a user account. In addition, the computer system where the directory system is resident may be a computer network including individual computers on the network and the changes to identified attributes may include changes to local attributes associated with the object being changed on an individual computer of the network.

As described above, some embodiments of the present invention may provide automated role transformation for directory objects, such as computer user accounts, by allowing administrators to leverage existing RBAC role templates to serve as the basis for updating accounts in addition to the conventional implementations of RBAC, which typically only address the creation and deletion of user accounts. Further examples of transformation operations according to various embodiments of the present invention will now be further described.

Where the directory object being changed is a user account, a typical change may be a change of job role and/or a location change. When a user changes locations and/or departments, several updates generally need to occur. The most complex of these changes is typically that of changing the person's group memberships to reflect their new role, but can include other items, such as moving the person's home directory, home share, profile path, Exchange mailbox and the like. For example, if a person changes from the IT Department to the Marketing Department, a number of changes may need to occur, including removal of IT-specific groups that the person is a member of and addition to Marketing-specific groups. Another change may be a transition from employee to contractor status or vice-versa. This situation is similar to a job or location change, but can potentially have security and confidentiality implications for the network administrator.

In changing group memberships, it is not generally enough to simply make one user look like another one (i.e., cloning) from the perspective of replacing the user's group memberships with those of an account template. Over time, employees may acquire group memberships that are not explicitly tied to their job function, but which can add work to the help desk when those memberships are lost because the account template used for a given job role is either out of date or ignorant of special considerations. For example, a new user in the Marketing Department may by default be a member of the following groups: Hou 18th Floor, Marketing, PR Interest and All Employees. A new user in the IT Department may by default be a member of the following groups: Hou 15th Floor, IT, Doom3 Players and All Employees. In an exemplary change situation, an IT employee named Bob who has been with the company for 2 years is changed. Bob is transferring to the Marketing department and will be moving to the 18th Floor, but will retain his participation in the Siebel Advisory Board. Bob is a member of the following groups: Hou 15th Floor, IT, Doom3 Players, All Employees, Chili Cookoff and Siebel Advisory Board.

The basic operation of cloning to make Bob's account have identical group memberships as that of a new Marketing user will fail to provide the desired result as Bob will, in that case, lose the group memberships he had that he needed and will likely end up calling the help desk at some point in the future to get all these corrected, probably over a series of phone calls, each as he discovers a group whose membership he has lost that he still needs. Thus, various embodiments of the present invention may provide for a transformation using account templates. For example, the administrator may have role-based user account templates that are associated with the specific IT role and specific Marketing role that may be used to guide the correct changes to group memberships.

In this case, to accomplish a transformation of Bob into a Marketing user who still is a member of the Siebel Advisory Board and Chili Cookoff, the transformation (morphing) task may add the group memberships associated with a desired final job role (Marketing user), subtract the group memberships specific to the old job role (IT user) and leave intact any group memberships that the user should retain because of non-role-specific responsibilities or project-specific groups that are not part of the generic role (Siebel Advisory Board and Chili Cookoff). Operations for the change may include the following high-level tasks: (1) select an account that will be modified in the morph operation; (2) select an existing user account that contains the group memberships associated with the desired job role that the person's account is being changed to fit; (3) select an existing user account that contains the group memberships associated with the job role that the person is leaving; (4) change one or more other Active Directory attributes of the user; and (5) commit the change(s).

An additive/subtractive model as with some embodiments of the present invention may be powerful because it can be used repeatedly to greatly reduce the amount of time required to update group memberships cumulatively. For example, a user who is changing departments may also be changing location. Thus, in the example of an IT person who moves from San Jose to Houston and joins the Marketing department, two transformation operations may be applied by a help desk user on the person's account. One operation may be used to transfer the user's group memberships associated with his department (IT to Marketing) and a second may be used to replace the user's group memberships for San Jose-specific groups with those of Houston-specific groups.

Thus, some embodiments of the present invention may provide a partial conversion of an existing user account to more closely match the group memberships of a user in a new location, business unit or department. Transformation scenarios may include adding group memberships based on a role template while removing group memberships based on another user account template. In this scenario embodiments of the present invention may have a help desk user select an account that needs to be changed (also referred to herein as transformed or morphed). The help desk user may also select an existing user account whose group memberships will be used to identify which groups the user needs to be removed from during the morph operation. The help desk user may also identify the user account template that has the group memberships that need to be granted to the user account being modified. Once those accounts have been identified, embodiments of the present invention may process the group memberships by removing group memberships associated with the template being removed from the account that are not held by the additive user account and adding group memberships held by the additive user account template that are not already held by the user account that is being modified.

In a further scenario, group memberships are added based on a user account role template. In this case, a help desk user may select an account that needs to be transformed and identify the user account template that has the group memberships that need to be granted to the user account being modified. Once those accounts have been identified, embodiments of the present invention may add group memberships held by the additive user account template that are not already held by the user account that is being modified. A further scenario is the removal of group memberships based on a user account role template. In this scenario, a help desk user may select an account that needs to be changed and an existing user account whose group memberships will be used to identify which groups the user needs to be removed from during the morph operation. Once those accounts have been identified, the group memberships may be processed by removing group memberships associated with the template being removed from the account that are held by the user template account. Thus, embodiments of the present invention provide for entirely additive or entirely subtractive user transformation operations, in addition to providing for concurrently adding and subtracting attributes such as group memberships.

Such operations will now be further illustrated by way of an example, where a user Jack Spratt is transferring from a European Sales ISR position to become a sales engineer. Jack's current group memberships are: Domain Users, EMEA Sales, All ISRs, Europe ISRs and European Employees. The company has a template user account called “Template EMEA ISR” that is a member of the groups EMEA Sales, All ISRs and Europe ISRs. The template user account for sales engineers in Europe is called “Template EMEA SE” and is a member of the groups EMEA Sales, All SEs and Europe Ses. An administrator/help desk user wants to process the transfer of groups for Jack's accounts. He selects Jack's user account, specifies that Jack is being removed from groups associated with “Template EMEA ISR” and being added to the groups associated with “Template EMEA SE.” After the transformation operation, Jack's group memberships will be: Domain Users, EMEA Sales, European Employees, All SEs and Europe SEs.

In various embodiments of the present invention, various supported group types may include: Global security, Global distribution, Local security, Local distribution, Universal security and/or Universal distribution. Query based group types may also be supported in some embodiments by providing for changes to underlying determinative attributes of a user or other object type. In addition, pre-commit summarization of group membership changes that will occur during a change may be provided to the help desk user. As such, when a help desk user is going through a change operation, they may see a basic summary showing the group membership changes (and additive/subtractive template user accounts) that will occur when the change user (or other object) transaction is committed.

As generally discussed above, some directory attributes may remain intact (unchanged) by default when changing an object, such as a user account. Where a change is not specified by a selected template or other help desk user input, such a default of unchanged may allow more user satisfaction with the change process. For example, directory attributes that are unrelated to group memberships being changed, such as managed by, direct reports, logon hours, and the like under Active Directory may remain unchanged unless modified by the help desk user implementing the change.

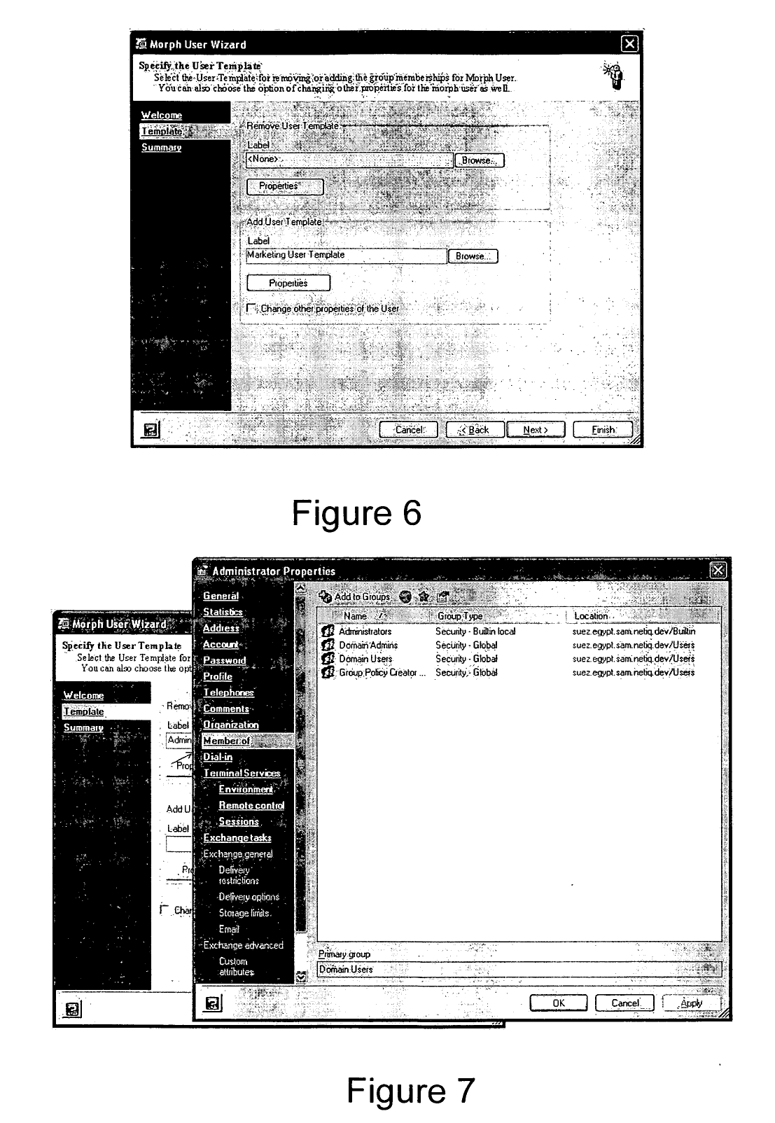

In some embodiments of the present invention, group membership attributes are treated differently than other attributes during a change. In such instances, group memberships to add and/or delete may be specified by selection of templates, where more than one template may be specified for adding and/or deleting. FIG. 6 illustrates a user template specification GUI, in particular a remove user template GUI and FIG. 7 illustrates a GUI with a list of group membership templates to choose from that may be called up responsive to selection of the Browse button in FIG. 6. In addition, an administrator or help desk user may choose to modify other properties (attributes) of the user during the operation. These other properties can include location information, telephone information and the like. To facilitate such designations, some embodiments of the present invention provide a help desk user requesting a change the option to update additional properties of the user beyond the group memberships as illustrated by the Change other properties of the User selection box in the GUI of FIG. 6.

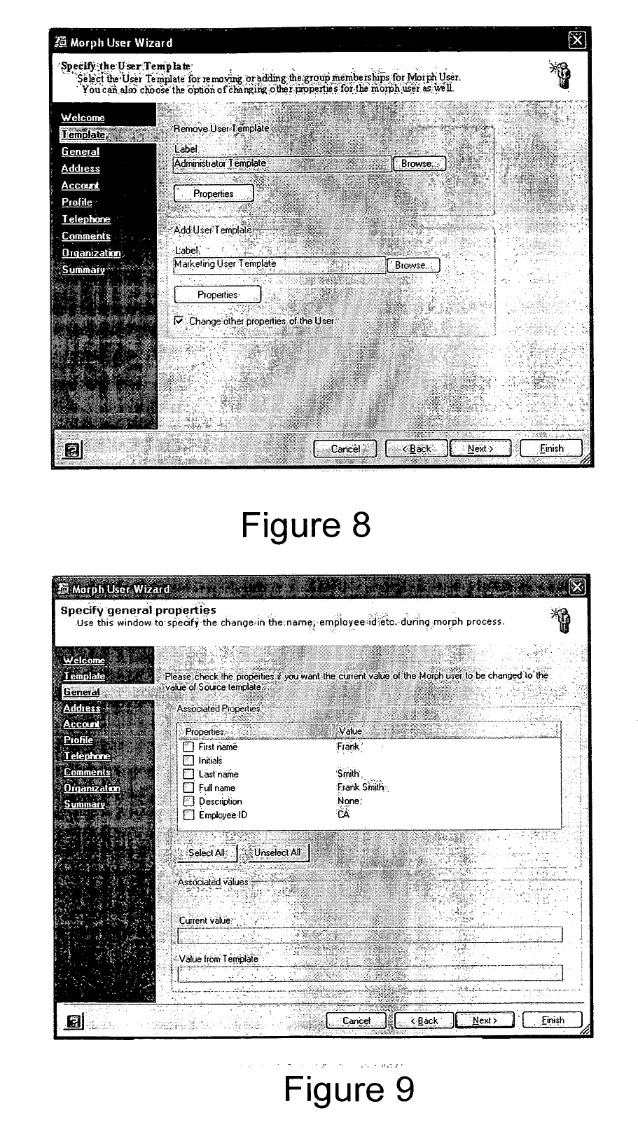

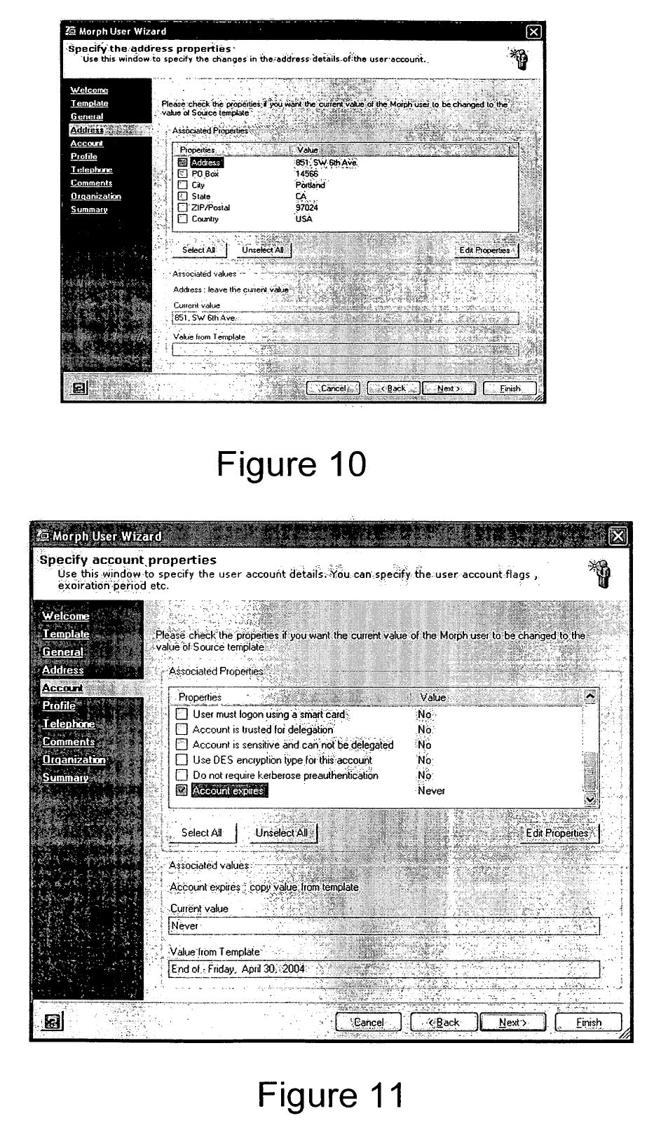

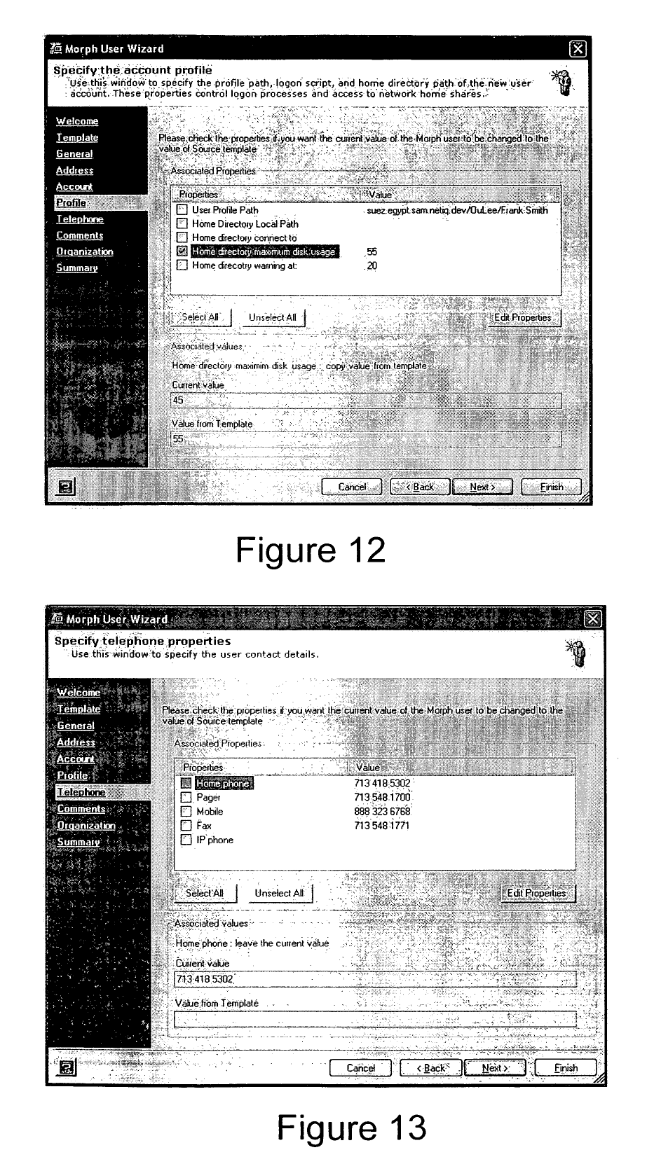

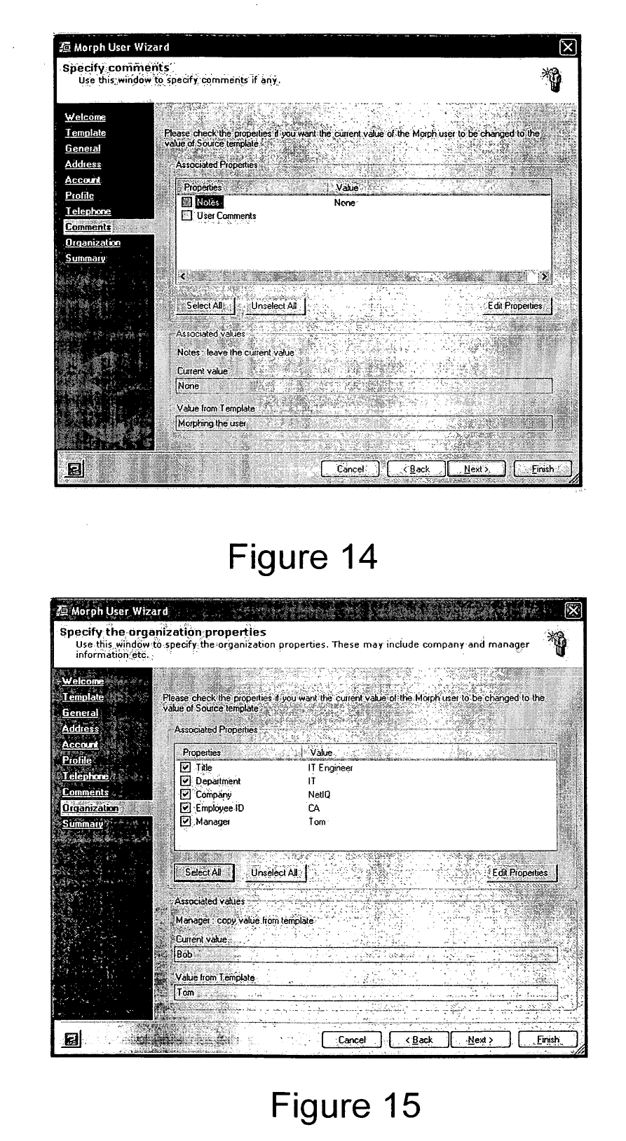

If this option is selected, then after the template accounts for group membership addition and subtraction have been selected, a GUI for the help desk user may expose a number of user properties that are exposed on key property pages as will be described further with reference to the exemplary GUI displays in FIGS. 8-15. In some embodiments, properties that govern group memberships may be hidden where it is desired to limit changes to properties that may themselves affect group memberships. Exemplary exposed properties may include properties categorized as General (FIG. 9), Address (FIG. 10), Account Properties (FIG. 11), Account Profile (FIG. 12), Telephones (FIG. 13), Comments (FIG. 14) and Organization (FIG. 15).

In some embodiments, the exclusion regarding exposing properties that may modify the group memberships of the user during the transformation transaction is to reduce the risk of or prevent potential power escalations, wherein a help desk user adds a user to groups or removes the user from groups that may result in the help desk user ending up with increased power over the modified user where some account template group memberships are themselves used, for example, to prevent particular help desk users from having access over certain accounts.

Security requirements may also be further considered in change operations. For example, a help desk user wants to change Bob's account from an IT departmental account into a Marketing account. In the customer organization, Marketing users' home shares reside on a different file server than those for IT users. Thus, the help desk user wants to update the home directory and home share path for Bob's account when it is changed into a Marketing user. In various embodiments of the present invention, the system may be configured to define which user accounts can be changed and by which other user accounts. In addition, which user account templates can be used in group membership change situation may be defined. Thus, security features may define whether a person can add a template account's group memberships to a managed user account, whether a person can subtract a template account's group memberships to a managed user account and the like. For example, a help desk user might be given the power only to change users from the HOUSTON OU in an additive way using a Marketing user account template.

Such a change may even result in a power de-escalation, causing the help desk person to lose powers over the target account after the change operation finishes. However, for security considerations, it may be desirable to limit or prevent power escalation, for example, by preventing group memberships from being modified beyond the addition or subtraction of group memberships implicit in a change transaction. For example, if a help desk user has the power to add group memberships to a managed user account from a Marketing template that contains two groups (GroupA and GroupB), when the help desk user applies the morph template to the managed user account “Bob,” Bob will be added to both GroupA and GroupB. Only after the change operation has finished will the help desk user be allowed to remove GroupA or GroupB from Bob's group memberships and, of course, only if the help desk user has been delegated that authority. An Administrator may set up some template user accounts that have group memberships for the job roles “IT Administrator,” “VP Marketing” and “VP Finance.” An administrator may then want to grant the Houston help desk the ability to change users in HOU and to only be able to add the group memberships associated with the “IT Administrator” template. As such, a change user operation may fail to allow a person to be added to or removed from a template that contains one or more group memberships (i.e. the entire operation may be blocked) and the help desk user may be notified when they attempt to perform a blocked change operation. For example, a help desk user tries to add Bob to an account template that is a member of Domain Admins (for which the help desk user lacks authority). The operation fails to execute any of the requested group membership changes for the account template and then notifies the help desk user of the reason for the failure.

In particular embodiments of the present invention, a user account that is being modified may be selected as an additive user account template. In this case, the net transaction will leave the user account unchanged. Where a user account that is being modified is selected as a subtractive user account template, all of the memberships of the user account to be changed will be deleted and new memberships may be added by specifying an additive template. Such a scenario generally corresponds to the clone approach used in conventional systems. As such, some embodiments of the present invention may be implemented to allow conventional approaches to be implemented as well for changes where so desired by a user.

Where a change operation fails for a violation of powers, policies or the like, some changes may be allowed to remain in effect (allowable changes that occurred before the violation). Alternatively, all of the changes in the transaction may be rolled back to the extent possible and the user may be informed of any changes that were not rolled back. In addition, an error message may be generated and/or logged to a transaction log.

An error message for a failed operation due to power escalation or the like may explain the reason for the failed operation. In addition, a log entry for the failed operation may include explanatory text referring to the power escalation or other cause. In addition, information may be logged in trace logs that may aid in diagnosing the reason for the power escalation. By way of example, a help desk user attempts to morph Bob into an IT user. The operation fails because it would result in an escalation of power of the help desk user over Bob's user account. The help desk user gets an error in the GUI informing him of this reason for the operation's failure. In addition, the reason for the failure of the change operation is entered in a log entry. Successful operations may also generate log entries including information such as the date/time of the operation, the user who initiated the task, the user account that was modified in the operation and/or the old and new group membership account templates.

As noted above, query-based distribution group memberships (QBDG) may also be changed in some embodiments of the present invention but not in others. Query-based distribution groups are a special case because their memberships are dynamic in nature and derived from other attributes. For example, a customer could have a QBDG called “Houston users” that is dynamically assessed and whose query places any user whose City attribute was “Houston” into the list. Thus, if a user is changed between departments, but the attribute around which the QBDG query is made remains unchanged, then the expected behavior is that the changed user will not be placed into or removed from the QBDG. For example, Bob's user account is set to a Department of “4567.” His user account is changed from an IT template into a Marketing template. The template account for the Marketing department also contains a “Department” attribute that is set to “1234.” Accounts with a Department of “1234” are also members of a QBDG called “Marketing Barflies.” In some embodiments of the present invention, Bob's Department attribute is not changed by the help desk user who performs the change operation on his account to “1234.” Therefore, the expected result is that Bob's user account will not be a member of the “Marketing Barflies” query-based distribution group.

In some embodiments of the present invention, change operations include changes extending beyond the directory system where the object is located. For example, a help desk user may be allowed to move the target user's Exchange 5.5 mailbox as part of a change operation or update Exchange 5.5 properties or distribution list memberships of the account being changed. By way of particular example, a help desk user may want to transform an IT user into a template held by Marketing users. The changed user's Exchange 5.5 distribution lists are updated so that the person now has the distribution list memberships of a Marketing user.

In further embodiments of the present invention, change operations may affect local properties of a computer on a network including the directory of the object. In such embodiments changes to user functionality may be directed to machine local users on managed servers and workstations.

In some embodiments of the present invention, change operations extend to managed groups that reside in a different domain than the user account being modified. In such embodiments, changes may be extend to group memberships in domains other than the one where the user account resides. For example, a user (DOMX\Bob) is going to be changed from an IT user (with template user account DOMX\IT Template) to a marketing user (with template user account DOMX\MKT). In this scenario, DOMX\IT and DOMX\MKT also happen to be members of a group in a trusted domain DOMZZZ that is also managed by the same server application as DOMX. DOMX\MKT also happens to be a member of DOMZZZ\Portland LAN Users. Changes may be extended to any group memberships held by the template accounts DOM\IT and DOMX\MKT where those template accounts were members of groups in DOMZZZ in some embodiments of the present invention.

Referring again to the GUI screens of FIGS. 6-15, the displays may be modified based on powers allocated to a help desk user or other administrator requesting a change. If the administrator only has the remove transforming power, only the “Remove User Template” may be active and the checkbox for editing other user properties may be read only. If the administrator only has the add power, only the “Add User Template” may be active. The administrator may also be able to select the checkbox that allows other properties of the user who is being transformed to be modified. If the administrator has both transform powers, the controls for selecting both templates may be active.

Clicking on Browse may launch the object selector window to choose the template for adding or removing (FIG. 7). Clicking on Properties may launch a pop up window to show the group memberships of the selected user template. In particular, Browse may only display templates for selection where the administrator has authority to select the template for a user being changed.

Once a template is selected, clicking the Ok button on the Object Selector dialog (FIG. 7) will close it and return the focus to the template page of the wizard (FIG. 6). The Remove Template edit box will be populated with the name of the selected user account. The Properties button may require the selection of a user object from the list box and display the Properties page focused on the ‘Member of’ tab for the selected user account (from Remove template or Add Template), showing the groups that will be removed or added from/to the Transform user depending on the selected template. Selecting the Other User Properties CheckBox will enable the administrator to edit other user properties during the transform operation. The default state of the checkbox may be unchecked and the other user property pages will not be displayed unless the checkbox is selected (Compare FIG. 6 (unchecked) to FIG. 8 (checked)).

All properties that the administrator has the power to view may be displayed in the property pages. A toggle button may be displayed as shown, for example, in FIG. 9. Selecting the toggle button for a property specifies the administrators desire to modify the property. The default values for the edit box used to modify the properties may contain the values of the properties for the Add Transform template.

The General properties page illustrated in FIG. 9 includes the properties available for editing including, First Name, Initial, Last Name, Full Name, Description and Employee ID. A list view is shown as being used to display the properties. Each row of the list view includes: a checkbox, the name of the property and the current value of the property for the user being transformed. The list view contains the properties for the tab and their current values. Highlighting a property will display the current and template values of the property in the ‘Associated Values’ box. The value displayed next to the property is the current value. If the check box is checked, the value displayed next to the property is the template value. The checkbox indicates that the user wants the value to be changed to the Source template value. The “Select All” button selects all the properties. This will change all the current values to the template values. The values shown next to properties will be the values if the operation is successful.

Clicking on “Unselect all” will unselect all the check boxes and values shown will be the current values. To change the value to any other than these two values, an administrator may have the option at the end of the designation operation to launch the property sheets to edit any properties.

The Address properties page is shown in FIG. 10. The following properties are shown as available for editing in FIG. 10: Street Address, PO Box, City, State, ZIP\Postal Code and Country. The Account properties page is shown in FIG. 11. The following properties, among others, are shown as available for editing in FIG. 11: Account is locked out, All User Account Flags and Account Expires. The Profile page is shown in FIG. 12, which shows user logon properties. The following properties are shown as available for editing in FIG. 12: User Profile Path, Home Directory Local Path and connect to, Home Volume disk Quota, max and warning.

The Telephone properties page is shown in FIG. 13. The following properties are shown as available for editing in FIG. 13: Home phone, Pager, Mobile, Fax and IP Phone. The Comments page is shown in FIG. 14. The following properties are shown as available for editing in FIG. 14: Notes and User Comments. The Organization properties page is shown in FIG. 15. The following properties are shown as available for editing in FIG. 15: Title, Department, Company, Employee ID and Manager.

Finally a summary page is shown in FIG. 16. This page shows a preview of the group changes that will be made to the user that is being transformed. Properties that are being changed will also be displayed on this page. If the check box is clicked, the properties sheets will be launched once the input process is finished, thus allowing a user to confirm the changes before they are implemented.

It will be understood that the GUI screens of FIGS. 6 to 16 are merely one example of a Wizard type user interface that may be utilized according to some embodiments of the present invention. In addition, while the illustrated examples relate to changes of group memberships and other attributes of user accounts, it will be understood that other object types and other attributes of user accounts may be changed in accordance with some embodiments of the present invention. Furthermore, it will be understood that the illustrated example properties are generally based on Active Directory attributes. However, it will be understood that the present invention is not limited to changing attributes of Active Directory objects and may be utilized with other directory systems on computer systems, either local or networked.

It will also be understood that other categories of properties for a user may be changed in some embodiments of the present invention. For example, a user's home directory and/or home share may be moved to a new server based on the new job role assigned to the user account. A new home directory quota may be assigned based on the new job role. Automatic updates of accounts in other directories than the one holding the role (i.e. if the transform user operation is initially initiated using a role template in Active Directory, then updates to other accounts held by that user on other systems, such as LDAP directories, mainframe and Unix accounts, database accounts and business applications such as Siebel, Oracle Financials, SAP, etc.) might be triggered by the transform user operation. By way of further example, updates to the user's mailbox location, delivery restrictions and/or mail quota may also be provided as well as updates to other directory attribute data (such as city, telephone, address, etc.) based on a job template.

Thus, as described above, various embodiments of the present invention may address the issue of how to quickly automate and simplify the change in access rights necessitated by a change in a person's responsibilities in their company. In addition to saving significant time for help desk personnel responsible for making the updates, some embodiments of the present invention may also ensure proper security by making sure that unneeded group memberships are not retained by the user after the transition.

The flowchart and block diagrams of FIGS. 1 through 5 illustrate the architecture, functionality, and operations of some embodiments of methods, systems, and computer program products for changing an object, such as a user account, associated with a directory system on a computer. In this regard, each block represents a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method for changing an object associated with a directory system of a computer system and having a current classification, the method comprising:
receiving a request to change the object, the request including a specification of a new classification of the object different from the current classification of the object;
retrieving a template identifying attributes associated with the new classification and/or the current classification responsive to the received request;
automatically identifying attributes of the object to change based on a comparison of the template associated with the new classification and/or the current classification and on current attributes of the object responsive to the received request; and
changing the identified attributes.

2. The method of claim 1, wherein the current classification and the new classification comprise a position, a role and/or a location of the object.

3. The method of claim 2 wherein the object comprises a user account and wherein the attributes include group memberships.

4. The method of claim 2 wherein automatically identifying attributes of the object to change comprises:
comparing attributes identified in the template associated with the new classification with the current attributes of the object; and
identifying attributes to add to the object that are identified in the template and are not current attributes of the object.

5. The method of claim 2 wherein automatically identifying attributes of the object to change comprises:
comparing attributes identified in the template associated with the current classification with the current attributes of the object; and
identifying attributes to drop from the object that are identified in the template associated with the current classification and are current attributes of the object.

6. The method of claim 5 wherein automatically identifying attributes of the object to change further comprises:
comparing attributes identified in the template associated with the new classification with the current attributes of the object; and
identifying attributes to add to the object that are identified in the template associated with the new classification and are not current attributes of the object.

7. The method of claim 6, wherein changing the identified attributes comprises dropping the identified attributes that are identified in the template associated with the current classification and are current attributes of the object and adding the identified attributes that are identified in the template associated with the new classification and are not current attributes of the object without changing other attributes of the object.

8. The method of claim 7, wherein changing the identified attributes comprises changing a plurality of attributes of the object while retaining at least one attribute of the object without change.

9. The method of claim 7, wherein the object comprises a user account and wherein the attributes include group memberships.

10. The method of claim 9, wherein the attributes further include identification, address, computer resource allocation, telephone and/or organization properties.

11. The method of claim 7, wherein changing the identified attributes is preceded by:
providing a summary of the identified attributes that will be changed; and
receiving a confirmation of the request to change the object responsive to providing the summary; and
wherein changing the identified attributes comprises changing the identified attributes responsive to receipt of the confirmation.

12. The method of claim 11, wherein receiving the confirmation includes receiving a designation of a change in a desired value of at least one of the identified attributes from the summary and wherein changing the identified attributes includes changing the attributes based on the designation of a change in a desired value.

13. The method of claim 7, wherein receiving a request to change the object comprises receiving the request from a user account having associated powers over the object to be changed and wherein changing the identified attributes comprises:
determining if any identified attribute to add would escalate the associated powers over the object to be changed of the user account requesting the change; and
generating an error notification and denying addition of the identified attribute that would escalate the associated power if it is determined that the associated powers would be escalated.

14. The method of claim 7 wherein the directory comprises an operating system directory of the computer system, a database directory and/or a secured computing application directory.

15. The method of claim 7, further comprising:
receiving a designation of desired values for attributes of the object not included in a retrieved template; and
wherein changing the identified attributes further includes changing attributes of the object to the received designated desired values.

16. The method of claim 7, wherein receiving a request to change an object comprises receiving a request to change a plurality of user account objects and wherein retrieving a template, automatically identifying attributes and changing the identified attributes comprises:
generating a worklist defining a task for each of the plurality of user accounts; and
automatically retrieving a template, identifying attributes and changing attributes for each of the plurality of user accounts based on the worklist.

17. The method of claim 7, wherein a plurality of objects are changed and wherein the method further comprises generating a log of changes to the plurality of objects.

18. The method of claim 7, wherein the object is a user account and wherein changing the identified attributes includes changing properties of an electronic mail (email) mailbox of the user account.

19. The method of claim 7, wherein the computer system comprises a network and wherein changing the identified attributes includes changing local attributes associated with the object on an individual computer on the network.

20. A system for changing attributes of an object associated with a directory system of a computer system and having a current classification, the system comprising:
a user interface configured to receive a request to change the object, the request including a specification of a new classification of the object different from the current classification of the object;
a template database including a template identifying attributes associated with the new classification and/or a template identifying attributes associated with the current classification;
an object transform module that identifies attributes of the object to change based on a comparison of the template associated with the new classification and/or the template associated with the current classification and on current attributes of the object and that changes the identified attributes.

21. The system of claim 20, wherein the object comprises a user account and wherein the attributes include group memberships.

22. The system of claim 21, wherein the request is received from a user account having associated powers over the object to be changed, the system further comprising:
a security module that determines if any identified attribute to add would escalate the associated powers over the object to be changed of the user account requesting the change and generates an error notification and denies addition of the identified attribute that would escalate the associated power if it is determined that the associated powers would be escalated.

23. A computer program product for changing an object associated with a directory system of a computer system and having a current classification, the computer program product comprising:
a computer readable medium having computer readable program code embodied therein, the computer readable program code comprising:
computer readable program code configured to receive a request to change the object, the request including a specification of a new classification of the object different from the current classification of the object;
computer readable program code configured to retrieve a template identifying attributes associated with the new classification and/or the current classification responsive to the received request;
computer readable program code configured to automatically identify attributes of the object to change based on a comparison of the template associated with the new classification and/or the current classification and on current attributes of the object responsive to the received request; and
computer readable program code configured to change the identified attributes.

24. The computer program product of claim 23, wherein the object comprises a user account and wherein the attributes include group memberships.

25. The computer program product of claim 24, wherein the request to change the object is received from a user account having associated powers over the object to be changed, the computer program product further comprising.
computer readable program code configured to determine if any identified attribute to add would escalate the associated powers over the object to be changed of the user account requesting the change; and
computer readable program code configured to generate an error notification and deny addition of the identified attribute that would escalate the associated power if it is determined that the associated powers would be escalated.
